(19) United States
(12) Patent Application Publication
(10) Pub. No.: US 2025/0020509 A1
(43) Pub. Date: Jan. 16, 2025

(54) SPECTROPHOTOMETERS AND RELATED METHODS

(71) Applicant: Charles River Laboratories International, Inc., Wilmington, MA (US)

(72) Inventors: John Weinacht, Seneca, SC (US); Andrew Casperson, Charleston, SC (US)

(73) Assignee: Charles River Laboratories International, Inc., Wilmington, MA (US)

(21) Appl. No.: 18/771,040

(22) Filed: Jul. 12, 2024

Related U.S. Application Data
(60) Provisional application No. 63/513,528, filed on Jul. 13, 2023.

(51) Int. Cl. G01J 3/28; B01L 3/00; G01J 3/02; G01J 3/433

(52) U.S. Cl. CPC G01J 3/2803; B01L 3/502715; B01L 3/50273; G01J 3/0286; G01J 3/4338

(57) ABSTRACT

Some aspects of the present disclosure are generally directed to spectrophotometers configured to be coupled to microfluidic sample cartridges. In some embodiments, spectrophotometers comprising less complex circuitry may lead to a more robust functionality with consistent optical sensing performance. This may include the use of components with different average lifetimes being positioned on different printed circuit boards, the use of integrated photodiode modules for sensing applications, and/or temperature sensors compressed between a heating block and one or more corresponding printed circuit boards.

### CROSS-REFERENCE TO RELATED APPLICATIONS

This Application claims the benefit of priority under 35 U.S.C. § 119(e) of U.S. Provisional Application Ser. No. 63/513,528, filed Jul. 13, 2023, the disclosure of which is incorporated herein by reference in its entirety.

### FIELD

Disclosed embodiments are related to spectrophotometers.

### BACKGROUND

Spectrophotometers generally comprise a light source and a detector, which are used to emit light and measure the intensity of transmitted light at various wavelengths, respectively. Accordingly, spectrophotometers leverage the light emitted from the light source by transmitting it through a sample and directing it towards the detector. In such schemes, any changes in the intensity of the emitted light measured at the detector may provide information regarding the sample, such as sample concentration, composition, and/or optical properties.

### SUMMARY

In some embodiments, a spectrophotometer includes a first printed circuit board; a second printed circuit board; a cavity disposed between the first printed circuit board and the second printed circuit board, where the cavity is configured to receive a sample cartridge disposed therein with one or more sample wells in fluid communication with one or more sample channels formed therein; one or more integrated photodiode modules disposed on the first printed circuit board; and a first set of one or more light sources disposed on the second printed circuit board. The first set of one or more light sources are configured to direct light towards the one or more integrated photodiode modules through the one or more sample wells when the sample cartridge is disposed in the cavity.

In some embodiments, a method for performing spectrophotometry on a sample includes: inserting a sample cartridge into a cavity disposed between the first printed circuit board and a second printed circuit board; aligning one or more sample wells of the sample cartridge between one or more integrated photodiode modules disposed on the first printed circuit board and a first set of one or more light sources disposed on the second printed circuit board; transmitting light from the first set of one or more light sources to the one or more integrated photodiode modules through the one or more sample wells; sensing the transmitted light with the one or more integrated photodiode modules; and determining one or more sample parameters based on the sensed transmitted light.

In some embodiments, a spectrophotometer includes: a first printed circuit board; a second printed circuit board; a heater block disposed between the first printed circuit board and the second printed circuit board; a cavity formed in the heater block, where the cavity is configured to receive a sample cartridge disposed therein with one or more sample wells in fluid communication with one or more sample channels formed therein; a heater thermally coupled to the heater block; a first temperature sensor disposed on the first printed circuit board, where the first temperature sensor is compressed against a first surface of the heater block; and a second temperature sensor disposed on the second printed circuit board. The second temperature sensor is compressed against a second surface of the heater block opposite from the first surface.

In some embodiments, a method for performing spectrophotometry on a sample includes: inserting a sample cartridge into a cavity disposed within a heater block between the first printed circuit board and a second printed circuit board; heating the heater block using a heater that is thermally coupled to the heater block; sensing a temperature of the heater block with a first temperature sensor disposed on the first printed circuit board and compressed against a first surface of the heater block and a second temperature sensor disposed on the second printed circuit board and compressed against a second surface of the heater block opposite from the first surface.

In some embodiments, a spectrophotometer includes: a first printed circuit board; a second printed circuit board; a cavity disposed between the first printed circuit board and the second printed circuit board, wherein the cavity is configured to receive a sample cartridge disposed therein with one or more sample wells in fluid communication with one or more sample channels formed therein; and a pump. The pump includes: a motor; and one or more pistons operatively connected to the motor. The one or more pistons are configured to apply suction to the one or more sample wells when the sample cartridge is disposed in the cavity and the spectrophotometer is operated. One or more processors are configured to control operation of the motor, and where when a current of the motor is greater than or equal to a threshold current, the one or more processors are configured to stop operation of the motor.

In some embodiments, a method for performing spectrophotometry on a sample includes: inserting a sample cartridge into a cavity disposed within a heater block between the first printed circuit board and a second printed circuit board; pumping fluid through the one or more sample channels to the one or more sample wells of the sample cartridge using a pump; and stopping operation of the pump when a current of the motor is greater than or equal to a threshold current.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIGS. 1A-1F show schematic diagrams of an exemplary embodiment of a spectrophotometer, according to some embodiments;

FIGS. 2A-2B show schematic diagrams of an exemplary pump for use in a spectrophotometer, according to some embodiments;

FIG. 3 shows a schematic diagram of an exemplary pump for use in a spectrophotometer, according to some embodiments;

FIG. 4 shows a schematic diagram of an exemplary sample cartridge, according to some embodiments;

FIG. 5A shows the arrangement of components on a first printed circuit board of a spectrophotometer, according to some embodiments;

FIG. 5B shows the arrangement of components on a second printed circuit board of a spectrophotometer, according to some embodiments;

FIG. 6 shows a plot of exemplary data collected from a spectrophotometer, according to some embodiments;

FIG. 7 shows an exemplary method for using a spectrophotometer, according to some embodiments; and

FIGS. 8A-8B show exemplary data collected using a spectrophotometer, according to some embodiments.

### DETAILED DESCRIPTION

The Inventors have recognized that optical sensing is widely used due to the variety of parameters that may be sensed using optics based sensing methods. Moreover, many optical sensing schemes are relatively simple and offer relatively high sensitivity for measuring absorbance and/or transmittance of light through a sample (e.g., with a spectrophotometer). Accordingly, optical sensing is often desirable and is widely used across various applications such as biochemical assays, chemical synthesis, and materials science. For example, optical sensing may be used with fluidic system for characterization of fluid based samples. This may include sensing applications in millifluidic and/or microfluidic systems.

The Inventors have also recognized that in most optical sensing systems, it is desirable to have extreme sensitivity for low limits of detection and/or for providing large dynamic sensing ranges. However, this may lead to the use of overengineered, expensive optical sensing systems that may also be fragile and require frequent calibration and/or maintenance to maintain appropriate operation of the system. For example, analog circuitry including separately engineered high performance photodiodes, amplifiers, and/or analog-to-digital converters are oftentimes used in such systems. However, these separately engineered and installed components are relatively expensive, may be complex to integrate in the system, and may be prone to failure. Additionally, for certain types of optical applications including, for example, spectrophotometers as disclosed herein, these types of photosensitive detection circuits may exhibit sensitivities that are magnitudes greater than may be needed to provide a desired sensitivity for sensing certain types of parameters (e.g., absorption of a transmitted light signal exceeding a threshold absorbance). In some instances, the complexity and expense of these overengineered and complex components on a printed circuit board may be further exacerbated by the integration of on-board controllers that provide on board computation and/or data processing. Specifically, the use of these integrated on-board controllers may again lead to increased complexity and may also result in a less reliable and more expensive system. Moreover, in previous systems, the designs did not account for the differing relative lifetimes of each component, where these components are typically included on a single board. Thus, the failure of a single component with a relatively short lifetime may necessitate the replacement of an entire circuit board comprising a number of other, potentially costly, components which may exhibit different expected lifetimes.

In view of the above, the Inventors recognized a need for more cost-effective, less complex, quicker performing, more robust, and/or more easily maintained optical sensing systems. Embodiments which may exhibit one or more of the above benefits, and/or other potential benefits different from those noted above, are detailed further below.

Some aspects of the present disclosure are related to using one or more integrated photodiode modules on-board (e.g., on the circuit boards) of spectrophotometers. Integrated photodiode modules, according to some embodiments, are robust, low-cost, and relatively lower-resolution sensors that may be inappropriate for use in most optical sensing applications, such as diagnostic sensors that need high accuracy sensors for correspondingly accurate measurements. Moreover, the wavelength range that may be sensed by integrated photodiode modules may be relatively limited, which may not be suitable in some optical sensing applications. However, the inventors have recognized in the context of the present disclosure that such integrated photodiode modules may be suitable for threshold sensing, wherein a relative change in a signal is being sensed, as opposed to conventional diagnostic sensing where an accurate absolute signal must be sensed to determine a desired parameter. This may be advantageous because the integration of robust, low-cost sensors may prove cost-effective and/or improve the lifetime of a system including the one or more integrated photodiode modules.

In view of the above, in some embodiments, a spectrophotometer comprising a first printed circuit board, a second printed circuit board, with a cavity disposed between the first printed circuit board and the second printed circuit board are described. In some cases, the cavity is configured to receive a sample cartridge disposed therein with one or more sample wells in fluid communication with one or more sample channels formed therein. The spectrophotometer may further comprise one or more integrated photodiode modules disposed on the first printed circuit board and a first set of one or more light sources disposed on the second printed circuit board, in accordance with some embodiments. The first set of one or more light sources are configured to direct light towards the one or more integrated photodiode modules through the one or more sample wells when the sample cartridge is disposed in the cavity. Thus, the one or more integrated photodiode modules may be used to perform spectrophotometry sensing of fluid samples introduced into the sample cartridges.

When using the above system, a sample cartridge may be inserted into the cavity between the first and second printed circuit boards. In some embodiments, the one or more sample wells of the sample cartridge may be aligned between the one or more integrated photodiode modules disposed on the first printed circuit board and the first set of one or more light sources disposed on the second printed circuit board. According to some embodiments, the spectrophotometry may further comprise transmitting light from the first set of one or more light sources to the one or more integrated photodiode modules through the one or more sample wells and sensing the transmitted light with one or more integrated photodiode modules. Any changes in the light intensity transmitted through the sample wells between the one or more light sources and the one or more integrated photodiode modules over a desired time period may be used to sense a desired sample parameter as elaborated on further below. For example, as described in more detail elsewhere herein, the time needed for an absorbance measured in a sample well to cross a threshold absorbance value may be correlated with a concentration of a target within a fluid sample.

Some aspects of the present disclosure are generally directed to spectrophotometers configured to be coupled to microfluidic sample cartridges. In some embodiments, it may be advantageous to use a spectrophotometer comprising less complex circuitry compared to previous generations of optical sensing devices, which may lead to more robust functionality and/or reduced cost of the system while maintaining a desired optical sensing performance of the system. According to some embodiments, control of the spectrophotometer may be relocated off-board, which may facilitate the simplification of on-board components and also facilitate the interface between the spectrophotometer and one or more remote processors (e.g., in an associated computer, a remotely located server, a smart device such as a smart phone or tablet, or other appropriate computing device). In some such cases, the one or more remote processors may comprise significantly more computer processing power than is feasible to introduce on-board the spectrophotometer, and may provide for quick control and/or data analysis. In some cases, improved temperature sensors and/or heating block arrangements with the spectrophotometer are used. In accordance with some embodiments, the components of the circuit boards of the spectrophotometer may be arranged such that the relative lifetime and/or costs of components on each circuit board are similar such that the failure of a single component may lead to a more cost-effective replacement of the relevant circuit board where a board including lower cost components with expected lifetimes that are shorter than those found on another circuit board may be easily replaced rather than needing to repair a circuit board that also includes expensive components with different lifetimes.

In some embodiments, a relevant process may be heated in order to facilitate and/or speed the reaction (e.g., catalytic reaction, cleavage reaction, etc.). However, previous systems provided a pin sensor positioned loosely in a correspondingly shaped hole formed in a heater block. The pin-in-hole sensors provided relatively low accuracy readings and need relatively frequent calibration. Improving the accuracy of the temperature readings and reducing the frequency of calibration are both desirable for improving temperature control and thus reaction control within the sensing system.

To provide the desired improved heating and/or thermal sensing, in some embodiments, a spectrophotometer may include a heater block disposed between the first and second printed circuit boards, where a cavity is formed in the heater block. The cavity may be sized and shaped to receive a sample cartridge as elaborated on further below. The heater block may be thermally connected to a heater, a first temperature sensor disposed on the first printed circuit board, and a second temperature sensor disposed on the second printed circuit board. The temperature sensors disclosed herein may correspond to any appropriate type of temperature sensor including, but not limited to, thermocouples, resistive temperature detectors (RTD), a semiconductor based temperature sensor, and/or any other appropriate type of temperature sensor. Thus, the heating block may be used to heat the sample cartridge when it is disposed in the cavity of the heating block. The first and second temperature sensors may be compressed against a first and second surface of the heater block opposite from the first surface by the associated first and second printed circuit boards disposed against the opposing first and second surfaces of the heater block. Such an arrangement may also compress the heater block between the first and second printed circuit boards. In some embodiments, the first and second temperature sensors may optionally be aligned with each other such that an axis perpendicular to both the first and second surfaces of the heater block may pass through both sensors, though instances in which the sensors are not aligned are also contemplated.

In some embodiments, the first and second temperature sensors in any of the embodiments described herein are board mounted temperatures sensors. As used herein, a board mounted component (e.g., sensor, processor, etc.) may refer to a surface mounted components that include electrical contacts that are soldered to corresponding electrical contacts on a surface of the printed circuit board without extending through the printed circuit board as may occur with pin-through-hole components where a pin extends through a hole and is soldered within a hole extending through the printed circuit board. Board mounting of the temperature sensors to the first and/or second printed circuit boards may help with a cost of the sensors and improve an ability of the sensors to be compressed against the heater block without causing cracking or other increased modes of failure. This may help to improve both the reliability and the accuracy of the temperature readings obtained using the temperature sensors, which may improve the temperature control of the spectrophotometer.

Performing spectrophotometry using a spectrometer including the above described thermal system and temperature sensors may include inserting a sample cartridge comprising one or more sample wells into the cavity disposed within the heater block between the first printed circuit board and a second printed circuit board and heating the heater block using a heater that is thermally coupled to the heater block. In some cases, a temperature of the heater block may be sensed with the first temperature sensor disposed on the first printed circuit board and compressed against the first surface of the heater block and the second temperature sensor disposed on the second printed circuit board and compressed against the second surface of the heater block opposite from the first surface. This use of sensors compressed against a surface of the heater block, rather than a single pin sensor floating within a hole filled with thermal grease as has been used in earlier systems, may provide more accurate temperature signals of the heater block and thus of the sample cartridge disposed therein. These temperature signals may be used to at least partially control operation of the heaters using any appropriate method including, for example, appropriate temperature feedback control loops. In some embodiments, the improved heating systems described herein may be used to heat the sample cartridge before and/or after aliquots of solution comprising a sample of interest is inserted into one or more inlets of a sample cartridge.

As noted above, certain aspects of the current disclosure are generally related to simplifying the components of the spectrophotometer present on-board (e.g., components physically present on the circuit boards of the spectrophotometer), for example, by remotely controlling the spectrophotometer by using one or more off-board processors. For instance, the sensors, one or more heaters, light sources, and other components may be configured to execute received commands and/or control signals. However, processing of these signals and active control of these systems may be performed by one or more processes that are remotely located from the one or more printed circuit board of the disclosed spectrophotometers. For example, a wired or wireless communication protocol may be used to connect the remotely located one or more processors with the associated components of any one of the embodiments of a spectrophotometer disclosed herein. In some specific embodiments, a pump including a motor may be configured to be controlled by one or more off-board processes that may send a commanded encoder position for a stepper motor, or other appropriate pump control parameter, to the pump. Moving control and analysis of the different signals and operations for a spectrophotometer off-board may be desirable for any of a variety of reasons. In some cases, off-board processing and control may facilitate the use of less complex circuitry which may be more cost effective, streamline performance of the circuitry, and/or provide more reliable operation of the system as there is no need to have a full onboard operating system for doing all these processes. Additionally, in some embodiments, off-board control may facilitate the use of more one or more processors which may exhibit increased computational power for device operation and/or data analysis.

As also noted above, the positioning of certain components on different printed circuit boards based on various considerations such as cost, lifetime, ease of replacement, and/or other considerations may be taken into account in any of the embodiments disclosed herein. For example, in some embodiments, less expensive components that may also be more prone to failure may be included on a first circuit board, while the remaining, more expensive and/or more reliable components may be included on a second circuit board. For example, less reliable components with shorter average lifetimes such as light sources (e.g., LEDs or other light sources), and optionally their associated control circuits may be located on a first circuit board. Correspondingly, the more reliable and/or expensive components, such as corresponding photosensitive detectors (e.g., photodiodes, integrated photodiode modules, or other appropriate types of photosensitive detectors), may exhibit longer average lifetimes and may be located on the associated second printed circuit board. In some such cases, grouping components that are prone to failure (e.g., exhibit a lower average lifetime) on the first circuit board may be desirable for easier and/or more cost-effective replacement and/or maintenance. That is, in previous systems, the failure of one component on a large printed circuit board including all of the necessary components with different average lifetimes necessitated the replacement and/or maintenance of the whole circuit board, which could entail high costs and/or long delays associated with either fixing and/or replacing the damaged circuit board. This problem is circumvented by the spectrophotometers described herein.

The systems and methods described herein may offer a number of different benefits. This may include reduced costs, increased reliability, and reduced system sizes as compared to earlier systems. Additionally, the systems and methods described herein are suitable for use in any of a variety of applications where an optical signal may be measured. For example, in some cases, the system and/or methods may be used to measure the progress and/or result of a biochemical and/or biomedical assay or general chemical reactions (e.g., cleavage reaction, precipitation reaction, synthesis, or the like). Thus, it should be understood that the various embodiments disclosed herein are not limited to any particular type of sensing application.

The sample cartridges disclosed herein may comprise one or more sample inlets in fluid communication with one or more sample wells formed in the sample cartridge. The sample inlets and wells may be fluidically connected via one or more corresponding sample channels extending therebetween. These one or more sample channels may in some instances also be connected to one or more corresponding outlets which may be configured to be connected to a vacuum source such as one or more pumps. For example, as described in more detail elsewhere herein, the one or more outlets of a sample cartridge may be configured to be fluidically connected with tubing and/or a pump of a spectrophotometer. The one or more outlets may be located downstream from sample wells along the one or more sample channels relative to the corresponding inlets. The sample channels may correspond to any appropriate size and, in some embodiments, may be microfluidic or millifluidic channels. Sample channels, fluid channels, and other similar terms may be understood as generally referring to a structure configured to direct the flow of fluid along a desired flow path and may either be partially open, fully enclosed, or exhibit any desired type of structure capable of being used with the systems and methods disclosed herein.

The one or more sample inlets, one or more sample wells, and one or more sample channels, in some cases, may be a plurality of sample inlets, a plurality of sample wells, and a plurality of sample channels, wherein each of the plurality of sample channels flow parallel to each other, as described in more detail elsewhere herein. In some embodiments, it may be desirable to have at least two sample inlets, at least two sample wells, and at least two sample channels in the sample cartridge to facilitate the analysis of a plurality of separate samples with a corresponding plurality of light sources and photosensitive detectors as described herein.

Each sample channel and/or sample well in the various embodiments described herein may have any of a variety of heights or widths. In some cases, the height and/or width of each of the one or more sample channels may be less than or equal to 2 mm, less than or equal to 1 mm, less than or equal to 750 microns, less than or equal to 500 microns, less than or equal to 300 microns, less than or equal to 200 microns, less than or equal to 100 microns, less than or equal to 50 microns, or less than or equal to 10 microns. According to some embodiments, the height and/or width of each of the one or more sample channels may be greater than or equal to 1 micron, greater than or equal to 10 microns, greater than or equal to 50 microns, greater than or equal to 100 microns, greater than or equal to 200 microns, greater than or equal to 300 microns, greater than or equal to 500 microns, greater than or equal to 750 microns, or greater than or equal to 1 mm. Combinations of the foregoing ranges are possible (e.g., greater than or equal to 1 micron and less than or equal to 2 mm). Other ranges are also possible. It should be understood that in some embodiments, the height and width of a channel may correspond to the in plane width which is contained with a plane in which the channels extend and out of plane height which may be perpendicular to the plane in which the channels extend. The height and width may be directed in directions that are perpendicular to each other and may also be perpendicular to a longitudinal axis of the channels extending along a length of the channels within the portion of the channel the height and width are referenced to.

Each sample channel may have any of a variety of lengths. In some cases, the length of each of the one or more sample channels may be less than or equal to 10 cm, less than or equal to 8 cm, less than or equal to 6 cm, less than or equal to 4 cm, or less than or equal to 2 cm. In some embodiments, the length of each of the one or more samples channels may be greater than or equal to 1 cm, greater than or equal to 2 cm, greater than or equal to 4 cm, greater than or equal to 6 cm, or greater than or equal to 8 cm. Combinations of the foregoing ranges are possible (e.g., greater than or equal to 1 cm and less than or equal to 10 cm). Other ranges are also possible.

The one or more sample wells of a sample cartridge may have any appropriate volume to accommodate an expected sample volume therein for testing purposes. Appropriate volumes of a sample well may be greater than or equal to 0.01 milliliter (mL), 0.05 mL, 0.1 mL, 0.2 mL, or any other appropriate volume. The sample well volume may also be less than or equal to 0.3 mL, 0.2 mL, 0.1 mL, or any other appropriate volume. Combinations of the forgoing are contemplated including, for example, a sample well volume may be between or equal to 0.01 mL and 0.3 mL. Other sample well volumes are also possible.

It should be understood that a sample cartridge may have any appropriate size and/or shape for accommodating the presence of the one or more sample inlets, channels, and wells formed therein. Thus, the sample cartridges and corresponding structures configured to receive the sample cartridges (e.g., a cavity configured to receive the sample cartridge within a spectrophotometer) are not limited to any specific size and/or shape as the disclosure is not limited in this fashion.

The integrated photodiode modules and/or infrared light sensors in any one of the various embodiments of a spectrophotometer disclosed herein may be used for threshold sensing in some instances, and as described elsewhere herein. In some such embodiments, the threshold value may be a threshold absorbance for light transmitted through the sample between a light source and corresponding photosensitive detector. This may be detected using relative changes in light intensity from an initial light intensity, a measured light intensity relative to an expected or reference light intensity, a change in magnitude of a measured light intensity, a measured light signal falling below a threshold light signal, or other appropriate threshold related to determining a threshold light absorbance being exceeded. In one such embodiment, the absorbance is described relative to a number extending between 0 and 1 where 0 is pure transmission with no absorbance (i.e., no sample present) and 1 is total absorbance of a light signal by a sample with no transmission. Depending on the application the absorbance threshold may be greater than or equal to 0.1, greater than or equal to 0.2, greater than or equal to 0.3, or greater than or equal to 0.5, or greater than or equal to 0.8. In some embodiments, the absorbance threshold may be less than or equal to 1, less than or equal to 0.8, less than or equal to 0.5, less than or equal to 0.3, or less than or equal to 0.2,. Combinations of the foregoing ranges are possible (e.g., greater than or equal to 0.1 and less than or equal to 0.8). According to some embodiments, when a threshold absorbance is measured at the infrared light sensors, the threshold absorbance represents the presence of a solution in the corresponding sample channels. In some cases, a threshold value measured at the integrated photodiode modules may be used to determine a sample parameter, for example, the presence and/or the concentration of a compound, particles, and/or other target species in the sample.

As used herein, integrated photodiode modules used with any one of the embodiments described herein may correspond to a semiconducting device corresponding to a single piece of semiconducting material that includes multiple electrical components that are formed in and/or disposed on and electrically connected to the components formed in the semiconducting material. Thus, in some embodiments, an integrated photodiode module may include components such as a photodiode, amplifier, and analog to digital converter that are formed in and/or attached to a single semiconducting substrate. The integrated photodiode modules used with the various embodiments described herein may be mounted to corresponding electrical contacts on an associated printed circuit board the integrated photodiode modules are attached to. This may include board mounting of the one or more integrated photodiode modules. As noted previously, a board mounted component may refer to a surface mounted components that include electrical contacts that are soldered to corresponding electrical contacts on a surface of the printed circuit board without extending through the printed circuit board. This is in contrast to pin-through-hole components where a pin extends through a hole and is soldered within the hole extending through the printed circuit board.

In accordance with some embodiments, the integrated photodiode modules used with any one of the embodiments described herein may have a relatively low resolution when compared with sensors used in conventional diagnostic sensors. Again, such sensors are not appropriate for use with conventional diagnostic sensors due to the high resolution requirements of those systems, and as such are not commonly used in optical sensing of fluid samples. For example, conventional systems use optical sensors with a resolution of greater than or equal to 24 bits, and may be up to 32 bits, in order to provide high accuracy measurements which are necessary for these high accuracy diagnostic tests. In contrast, the integrated photodiode modules used herein may have relatively lower resolutions because the threshold sensing described elsewhere herein does not need such precise measurements to determine the presence and/or concentration of the species of interest. For instance, in some cases, the resolution of the integrated photodiode modules may be greater than or equal to 12 bits, greater than or equal to 14 bits, or greater than or equal to 16 bits. In some embodiments, the integrated photodiode modules may have a resolution of less than or equal to 18 bits, less than or equal to 16 bits, or less than or equal to 14 bits. Combinations of the above are contemplated including an integrated photodiode module with a 12 bit to 18 bit resolution. In some embodiments, it may be desirable to use a 16 bit integrated photodiode module because they are widely commercially available.

Integrated photodiode modules may be smaller and/or more compact than equivalent separately formed analog circuits. In comparison to conventional sensors used for diagnostic devices, integrated photodiode modules are relatively cost-effective due to their use in cellular devices and the corresponding push to provide sufficient supply. Likewise, due to their use in cellular devices rather than diagnostic devices, though integrated photodiode modules have lower resolution than conventionally used sensors, and thus one of ordinary skill would not consider using integrated photodiodes for such a sensing application. However, the inventors have recognized in the context of the present disclosure that the resolution afforded by integrated photodiode modules may be sufficient for certain sensing applications while also offering increased reliability, decreased cost, and reduced design complexity.

As noted above, in any one of the embodiments described herein, some and/or all of the components of the spectrophotometer may be controlled off-board. Generally, off-board control is a configuration where computational tasks and/or data processing are performed off-board by one or more remotely located processors (e.g., an adjacent computer, tablet, smartphone, separate control system, a remotely located server, and/or any other computing device capable of controlling a spectrophotometer to perform any one of the methods disclosed herein). That is, computational tasks related to the analysis and control of the various components may occur on the one more remotely located processors. In some cases, for examples, commands for the various components may be transmitted via an off-board computational system and relayed to the on-board components. After receiving the commands from off-board, the components may perform corresponding actions and relay subsequently collected information (e.g., signals from the one or more sensors) back to the one or more off-board computer processors. Any received signals may then be processed by the off-board computer processor as detailed further herein.

Configuring the spectrophotometer for off-board control may be desirable for any of a variety of reasons. For example, this may facilitate the use of more powerful computational resources and/or storage capacity than may otherwise by achievable on-board without excessive costs, increased complexity, and/or decreased reliability. Moreover, off-board control may facilitate the simplification of the components of the spectrophotometer, which may again be desirable for the above noted reasons. Note that, in some embodiments, the on-board control of the spectrophotometric process may still be possible.

It should be understood that the above descriptions of various components as well as the specific ranges for different parameters may be used with any one of the embodiments of a spectrophotometer as described herein. Further, these various components and ranges may either be used individually and/or together in any desired combination with the various embodiments of a spectrophotometer described herein.

The spectrophotometers described herein may be suitable for sensing any of a variety of sample parameters, as long as the spectrophotometer is capable of measuring the sample parameter. That is, the spectrophotometer can be used to sense any of a variety of optical signals, for example, the attenuation of light transmitted through a sample. The attenuation may be attributed to the absorbance of the light by the sample. In some cases, any changes in the absorbance as a function of time may be correlated to reaction rates and/or concentrations of a target species (e.g., compounds, particles, bound or cleaved dye, etc.) within a sample. Depending on the application, the signal may either be constant with time, or it may vary with time as elaborated on further below.

In one exemplary embodiment, the spectrophotometers disclosed herein may be used to determine the presence and/or concentration of a chromogenic endotoxin. When a sample comprising the chromogenic endotoxin is spiked with an enzyme that reacts with the chromogenic endotoxin, the absorbance of the chromogenic endotoxin may change.

Accordingly, the spectrophotometer may measure the absorbance of the sample as a function of time after introducing the enzyme that reacts with the chromogenic endotoxin. In some embodiments, as described in more detail elsewhere, the spectrophotometer may sense the changing absorbance of light transmitted through the system (e.g., by sensing the corresponding change in transmission of light through the sample) using threshold based sensing. In such an exemplary embodiment, if the absorbance threshold is exceeded, the presence of the chromogenic endotoxin is confirmed, whereas the time it takes to sense the signal exceeding the absorbance threshold may be correlated with the concentration of the chromogenic endotoxin.

Generally, the spectrophotometers described herein may be used in any of a variety of sensing schemes involving optical signals, wherein the optical signal may be large enough to measure with threshold based sensing. Exemplary systems include cleavable dyes, wherein once a co-reactant is introduced, the concentration of the cleavable dye changes. In some such cases, the measure absorbance of the sample may increase as the cleavable dye reacts, whereas in other such cases, the measured absorbance of the sample dye may decrease as the cleavable dye reacts. In some embodiments, the spectrophotometer may be used to measure contamination of biological and/or biomedical samples. Measuring the occurrence and/or progress of other chemical reactions are also possible, in accordance with some embodiments, such as precipitation reactions, catalytic reactions that generate light absorbing compounds, and/or changes in pH in the presence of pH dependent light absorbers.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

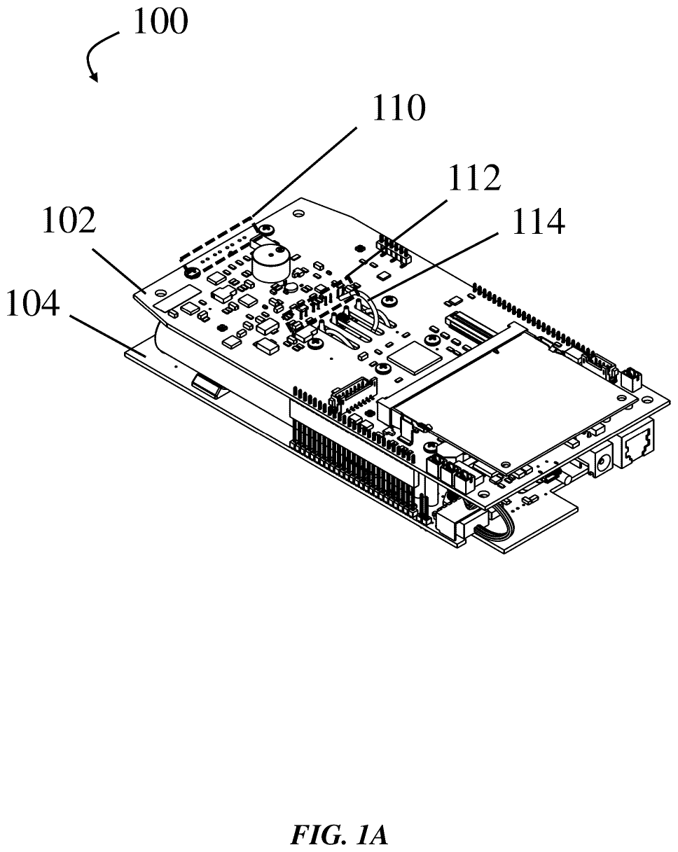

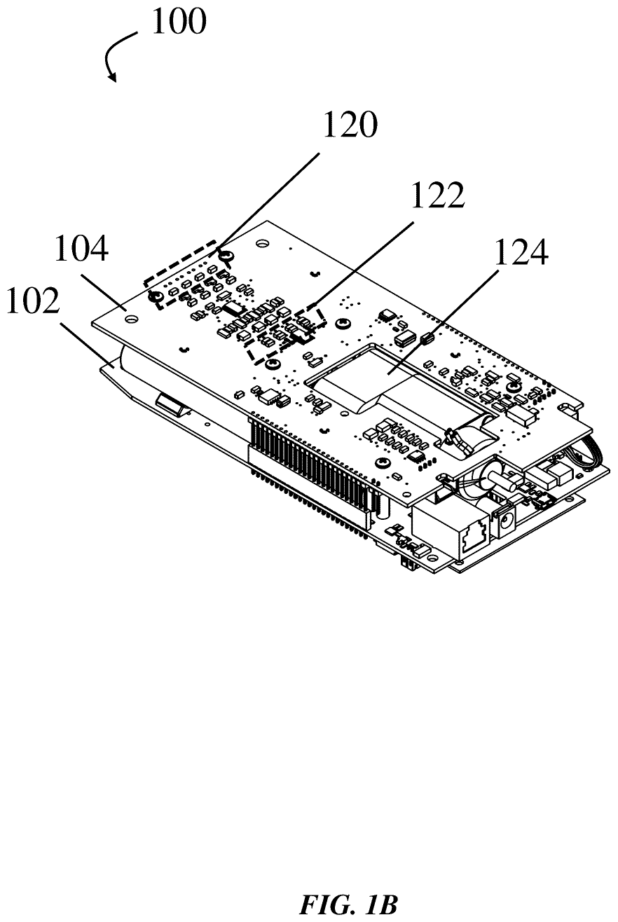

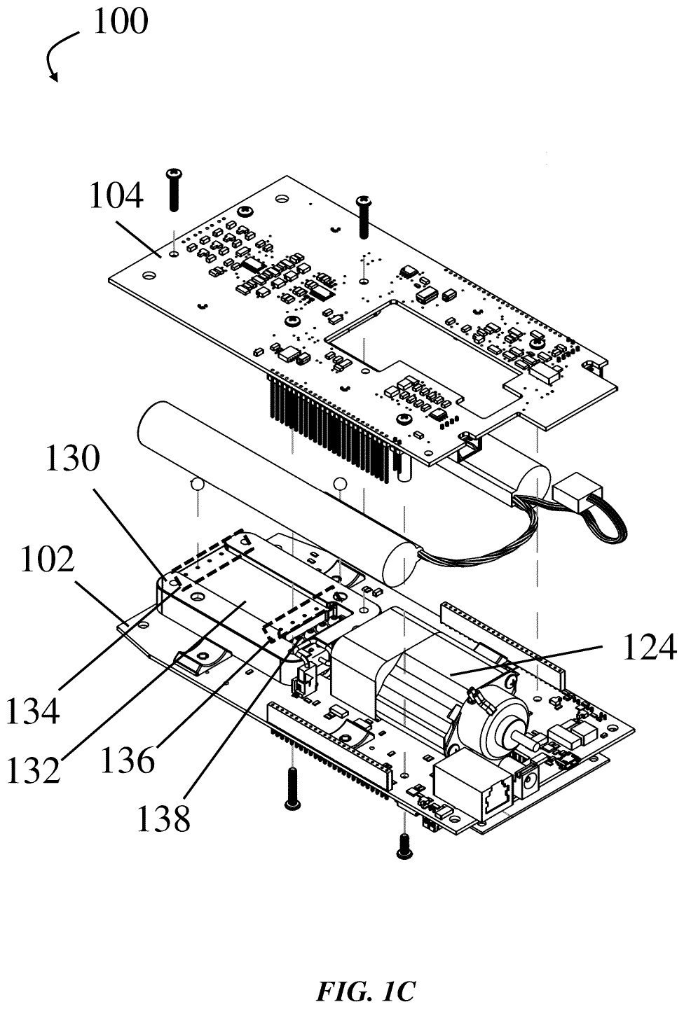

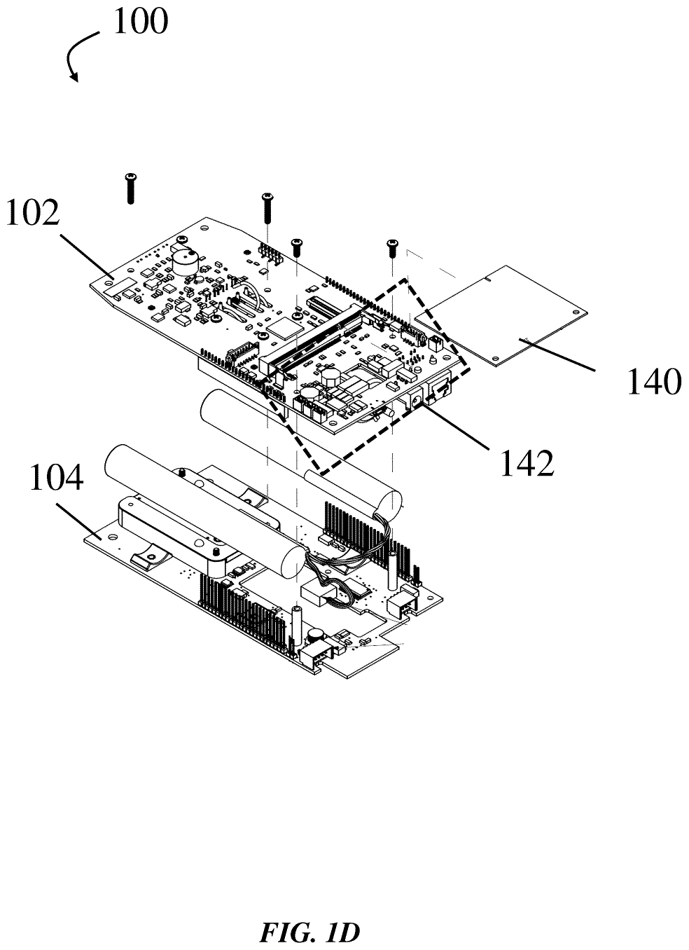

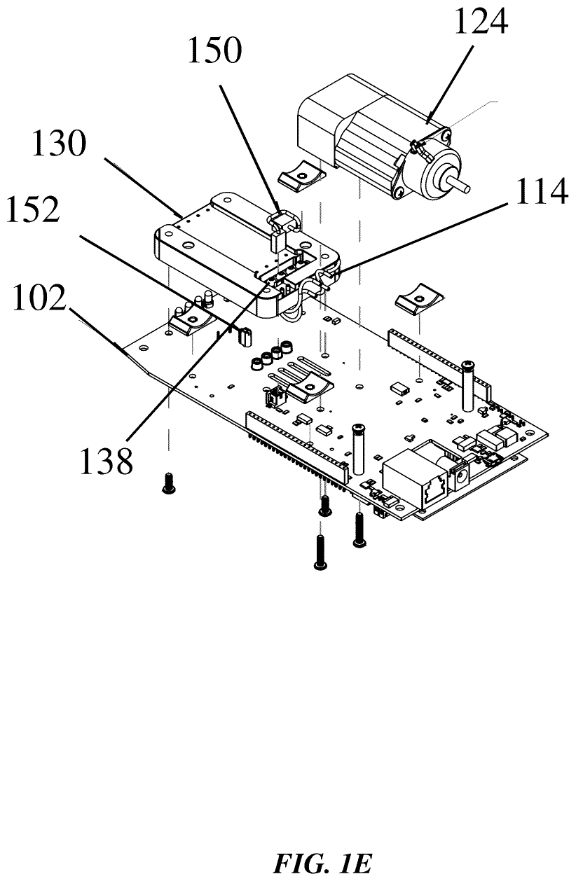

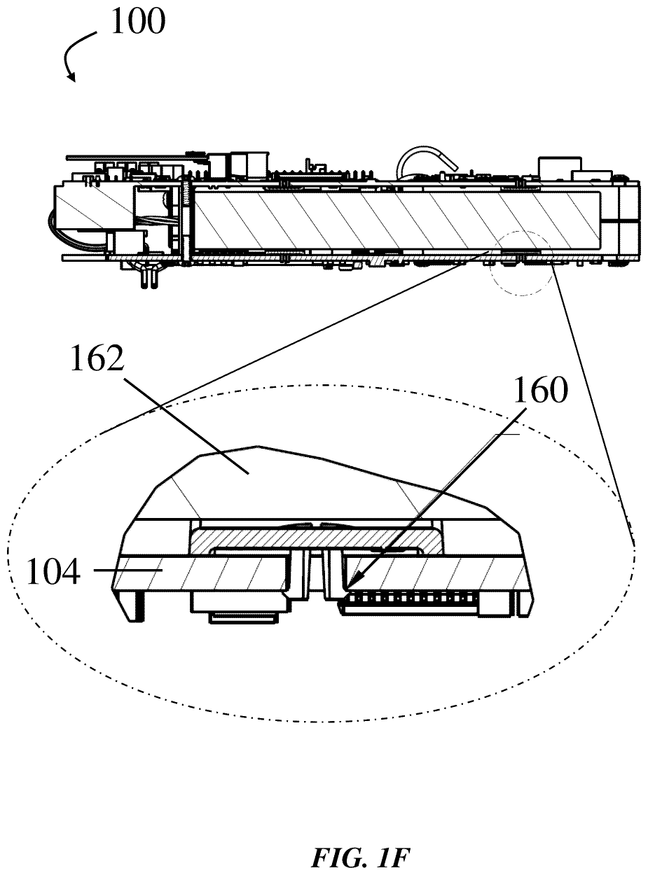

FIGS. 1A-1F show schematic diagrams of an exemplary embodiment of a spectrophotometer as described herein. FIG. 1A shows a top perspective view of the fully assembled spectrophotometer 100. The spectrophotometer 100 comprises a first printed circuit board 102 and a second printed circuit board 104, one or more integrated photodiode modules 112, one or more infrared light sensors 110, and tubing 114 in fluid connection with a pump 124 which may be disposed at least partially between the first and second printed circuit boards 102 and 104. The one or more integrated photodiode modules and the one or more infrared light sensors may be included on the first printed circuit board which may include the more reliable and/or more costly components in the depicted embodiment.

FIG. 1B shows a bottom view of the fully assembled spectrophotometer 100. The second printed circuit board comprises a first set of one or more light sources 122 and a second set or one or more light sources 120. Again the light sources may exhibit lower average lifetimes and be lower costs as compared to the photosensitive detectors (e.g., the one or more infrared light sensors and the one or more integrated photodiode modules). The pump 124 is disposed partially between the first and second printed circuit boards 102 and 104 and may extend partially out of a cutout in the second printed circuit board as can be seen in FIG. 1B. The first set of one or more light sources may be aligned with and oriented towards the corresponding one or more infrared light sensors which may be located on the corresponding printed circuit boards in a location such that one or more corresponding sample channels of a sample cartridge may be disposed therebetween when the sample cartridge is disposed in the spectrophotometer. Correspondingly, the second set of one or more light sources may be aligned with and oriented towards the corresponding one or more integrated photodiode modules which may be located on the corresponding printed circuit boards in a location such that one or more corresponding sample wells of a sample cartridge may be disposed therebetween when the sample cartridge is disposed in the spectrophotometer.

FIG. 1C shows an exploded, bottom perspective view of the spectrophotometer 100. As illustrated in the figure, a heater block 130 is disposed between the first and second printed circuit boards 102 and 104. The heater block 130 may include a cavity 132 sized and shaped to receive a sample cartridge disposed therein. The illustrated heater block corresponds to a first portion of a heater block with first portion of the cavity formed in it. The first portion of the heater block may be coupled to a second portion of the heater block to form the overall heater block. However, instances in which a single integral heater block with a desired cavity formed therein is provided are also contemplated. In either case, the heater block may be formed from a sufficiently thermally conductive material such that the heater block may transfer heat to and/or from the sample cartridge when it is disposed in the cavity. Accordingly, a heater, such as a resistive heating element, thermal tape, or other appropriate type of heater, may be thermally coupled to the heater block. Accordingly, when a sample cartridge is inserted into the cavity 132, it may be heated to a desired temperature by the heater block 130, which again may include a heater (not depicted), and as described in more detail elsewhere herein. Note, however, that in some embodiments, the heater block may not be present, and the sample cartridge may not be heated as the disclosure is not so limited.

FIG. 1C also illustrates the presence of optical paths 134 and 136 that extend through the heater block 130 so that light can be transmitted from the first and/or second set of one or more light sources 120 and 122 through the heater block 130, and the sample cartridge when present, to the infrared light sensors 110 and/or integrated photodiode modules 112 respectively. Specifically, in the depicted embodiment, a series of through holes formed in and extending through the heater block are aligned with the corresponding one or more light sources and photosensitive detectors (i.e., the infrared light sensors and the integrated photodiode modules) such that the optical paths permit light to pass through these opening of the heater block. In such a manner, the sample cartridge (e.g., comprising a sample) may be heated by the heater block before, during, and/or after measuring optical properties of the sample in the sample cartridge using the infrared light sensors 110 and/or integrated photodiode modules 112 of the spectrophotometer 100. Additionally, fluid connection ports 138 may be configured to mate with and seal to corresponding outlets of the sample channels of a sample cartridge as elaborated on further below. This may place the sample channels of the sample cartridge in fluid communication with the tubing 114 and the pump 124 the tubing is connected to when the sample cartridge is inserted into the heater block 130.

FIG. 1D shows an exploded, top perspective view of the spectrophotometer 100. Here, upon removal of Micro SD 140, the underlying circuitry and drivers 142 for the motor pump are shown.

FIG. 1E is another exploded view of the spectrophotometer showing a bottom portion of the heater block 130, pump 124, and various components on the first printed circuit board 102. This view shows how tubing 114 extends from a location where it may be connected to a port of the pump 124 (not depicted) and through an exterior surface of the heater block to the connection ports 138 incorporated with, or disposed in, the heater block 130, though other arrangements of the tubing and/or connection ports are also contemplated. In either case, when the sample cartridge is present, the sample inlets, channels, and wells are fluidically connected to the pump 124 via the tubing. Additionally, an electrical connection of a heater (not depicted) that is included in the heater block 130 may be electrically connected to electrical contacts, pins, or other power source on the first printed circuit board 102 using a cable 150. Finally, one or more temperature sensors 152 may be disposed on the first printed circuit board 102. The one or more temperature sensors may be board mounted to the first printed circuit board and may be compressed between an exterior surface of the heater block 130 and a corresponding surface of the first printed circuit oriented towards the heater block and that the one or more temperature sensors are mounted to when the spectrophotometer is fully assembled. To help improve thermal coupling between the one or more temperature sensors and the heater block, a heat transfer paste may be applied between a thermal contact pad of the one or more temperature sensors and the heater block the thermal contact pad, or other appropriate portion of a temperature sensor, is compressed against. While not illustrated in the figure, one or more temperature sensors may also be included on, and optionally board mounted to, the second printed circuit board such that the one or more temperatures sensors are compressed between an exterior surface of the heater block 130 and a corresponding surface of the second printed circuit oriented towards the heater block and that the one or more temperature sensors are mounted to when the spectrophotometer is fully assembled. Thus, the temperatures sensors may be compressed between the heater block and a corresponding printed circuit board. In some embodiments, the one or more temperature sensors may include a first temperatures sensor and a second temperature sensor positioned on opposing sides of the heater block and aligned with each other, though embodiments in which the temperatures sensors are not aligned with one another are also contemplated.

The above noted arrangement of one or more temperature sensors, and preferably two temperature sensors located on opposing sides of a heater block, which are compressed against a heater block may offer improved accuracy relative to other temperature sensing arrangements. For example, in some embodiments, a sensed temperature, which may correspond to an average of the temperatures sensed by the separate temperature sensors, may have an offset from an actual temperature of the heater block that is less than or equal to 0.5° C., 0.4° C., 0.3° C., 0.2° C., or another appropriately low temperature offset. Due to the compression of the temperature sensors against the heater block surfaces, such an arrangement may exhibit little to no drift over time and may be much more accurate as compared to other prior methods of measuring a temperature of the heater block such that calibrations of the temperature sensors may be less frequent and/or unnecessary in some embodiments as compared to the earlier designs described above.

FIG. 1F shows a side cross sectional view of the fully assembled spectrophotometer, as well as a magnified view of a portion of the side of the fully assembled spectrophotometer. As depicted in the figure, the first and second circuit boards 102 and 104 may be mechanically connected to other portions of the spectrophotometer, such as a body 160 and/or other components of the spectrophotometer, using one or more snap connectors 160, bolts, mechanical interlocking features, clips, adhesives, solder, and/or any other appropriate type of connection may be used as the disclosure is not so limited.

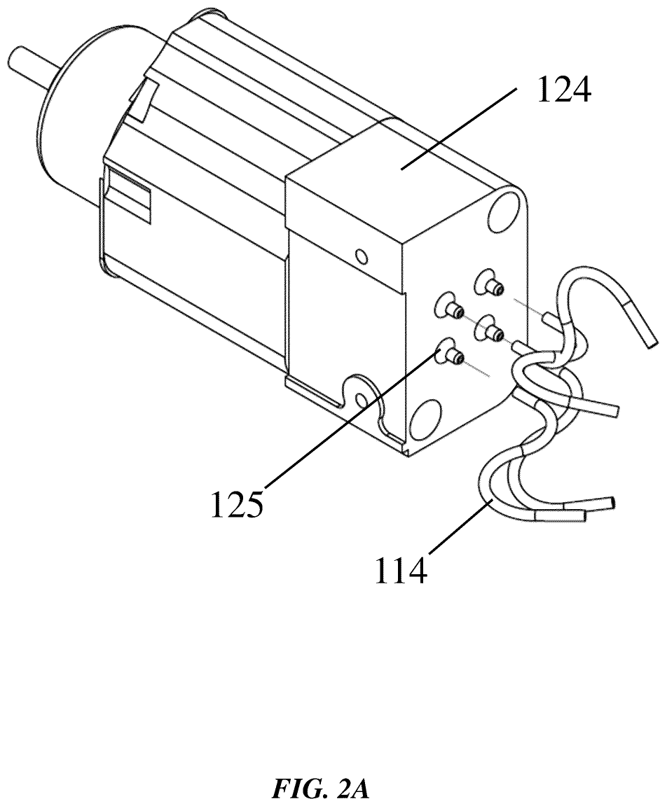

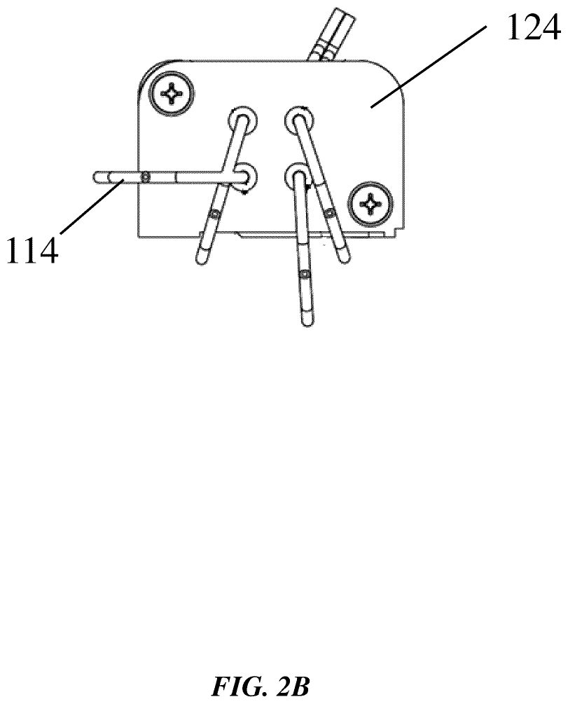

Schematic diagrams of one embodiment of a pump 124 that may be used in any one of the spectrophotometers disclosed herein are shown in FIGS. 2A and 2B. The pump 124 comprises one or more connection ports 125 to which tubing 114 may be connected. As shown in FIG. 1A, the tubing may optionally be arranged such that it passes out of and pack into slots formed in the first circuit board with a distal end of the tubing opposite from the pump may be connected to the one or more corresponding connection ports configured to be connected with the one or more corresponding outlets of the sample channels of a sample cartridge as detailed further below. As shown in the figure, in some embodiments, the pump may include multiple ports and separate tubing may be connected to each port. In such an embodiment, the pump may either apply a common suction to each port and tubing, or separate pumps included in the overall pump may be configured to apply separately controlled suctions to the separate ports, tubing, and associated sample channels. Accordingly, either coordinated or separate control of the separate sample channels of a sample cartridge may be employed depending on a desired application.

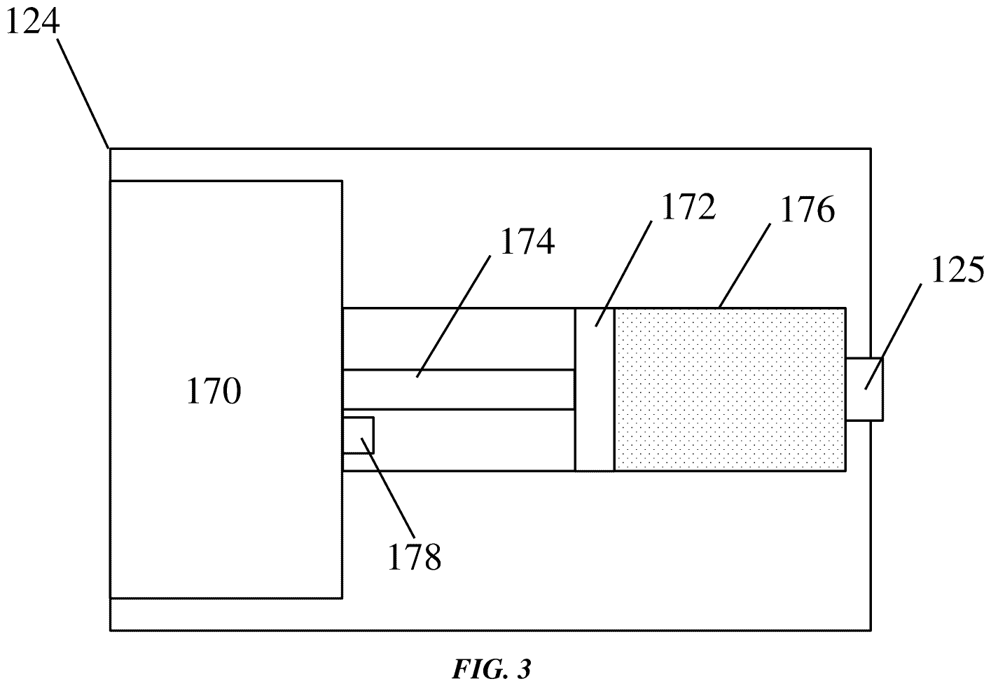

FIG. 3 shows a general embodiment of an exemplary pump 124 that may be used with any one of the embodiments of a spectrophotometer disclosed herein. The pump comprises motor 170, piston 172 having piston rod 174 operatively connected to the motor, compression volume 176, and connection port 125. The motor 170 is configured to either directly or indirectly drive movement of the piston 172 in a compression direction (i.e., into the compression volume) which draws a fluid into the compression volume 176 through the connection port 125. This applies suction to any tubing 114 that may be connected to the pump 124 by the connection port 125. While a piston rod is shown, other arrangements for transferring motion between the piston and the motor are also possible including, but not limited to, direct electrical drives, other gearing arrangements, belts, cables, and/or any other appropriate method for displacing the piston in a desired direction. In some embodiments, a current sensor 178 may be included in the pump 124, though embodiments in which a separate current sensor is not used and an integrated controller of the pump capable of determining an applied current is used as a current sensor are also contemplated. In either case, the current sensor may be configured to sense or otherwise monitor a current applied to the pump during operation. This current signal may be transmitted to one or more processors which may be configured to control operation of the pump based at least in part on the received one or more current signals. The one or more processors may be located off-board in some embodiments. Typically, operation of the pump may be controlled based on a commanded displacement, number of steps for a stepper motor, or other appropriate type of command without reaching an end of travel. However, in some instances, a piston, or other pump arrangement, may inadvertently reach an end of travel outside of a desired range of motion, or an obstruction may be present preventing operation of the pump. In such an instance, a current of the pump may increase beyond a desired current threshold. Accordingly, in some embodiments, the one or more processors may be configured to control operation of the pump by stopping movement of the pump when a threshold current is exceeded by operation of the pump.

While a piston based pump is described above, it should be understood that any appropriate type of pump or other suction source capable of causing a sample to flow through a sample cartridge may be used as the disclosure is not so limited. This may include, but is not limited to, positive displacement pumps such as peristaltic pumps, though any appropriate type of suction source may be used.

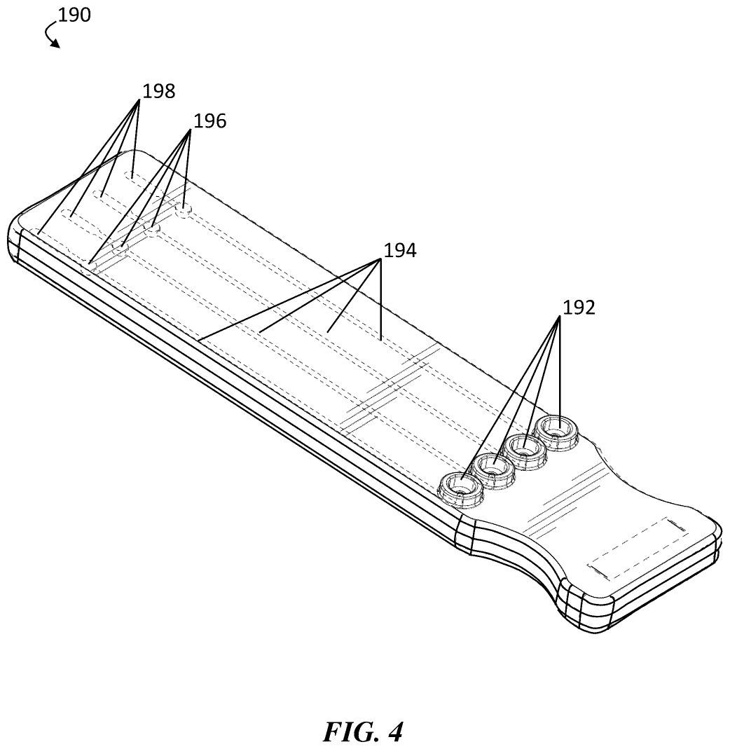

FIG. 4 shows an exemplary embodiment of a sample cartridge 190 which may be configured to be inserted into the cavity of a spectrophotometer as embodied in FIG. 1A and/or any other embodiment of a spectrophotometer disclosed herein. The sample cartridge 190 comprises a plurality of sample inlets 192, a plurality of separate sample channels 194 fluidically connected to and extending away from the separate sample inlets 192 in a one to one fashion and in a downstream direction. A plurality of sample wells 196 are disposed along separate flow path extending along the sample channels 198 such that each sample well is in fluid communication with a separate sample inlet of the plurality of sample inlets at a downstream location along the associated sample channel. Note that in this exemplary embodiment, there are four sample inlets, channels, and wells, but the plurality of each of these elements may comprise any of a variety of numbers (e.g., greater than or equal to 2, greater than or equal to 5, greater than or equal to 10, or the like). Additionally, while the sample channels may flow parallel to each other along a straight flow path as illustrated in this exemplary embodiment, it is also possible to use a sample cartridge comprising sample channels with more complex shapes, for instance, for passive mixing and/or other functions. In some embodiments, the sample cartridge may also include a one or more corresponding outlets 198 fluidly connected to the corresponding one or more sample channels at a location downstream from the sample wells. For example, separate outlets may be fluidly connected to the separate sample channels and associated sample wells. The sample outlets may be configured to be connected to one or more corresponding pumps or other vacuum source as detailed previously above.

In this exemplary embodiment, the sample cartridge 190 is configured to be inserted into a spectrophotometer, where an aliquot of solution comprising a sample may be inserted into each of the sample inlets 192 of the sample cartridge. A pump 124 may then be operated to pump liquid from each of the sample inlets through each of the sample channel 198 to each of the sample wells 196. As the liquid is pumped through the sample channels, the second set of one or more light sources 120, see FIGS. 1A-1C, may direct light through each of the plurality of sample channels 194 at a location between the sample inlets 192 and sample wells 196 towards the one or more infrared light sensors 110. A change in the absorbance measured at the infrared light sensors 110 aligned with the separate sample channels of the sample cartridge may signal that the solution is present and/or flowing through the sample channels 194. The sample wells 196 may be aligned with the first set of one or more light sources 122 and the one or more integrated photodiode modules 112 when the sample cartridge is inserted into a cavity of a spectrophotometer, such that light emitted from the first set of one or more light sources 122 may transmit through the sample wells 196 towards the integrated photodiode modules 112. Any change in absorbance measured at the integrated photodiode modules may be correlated to the presence and/or concentration of a species of interest in the sample solution in the sample wells 196.

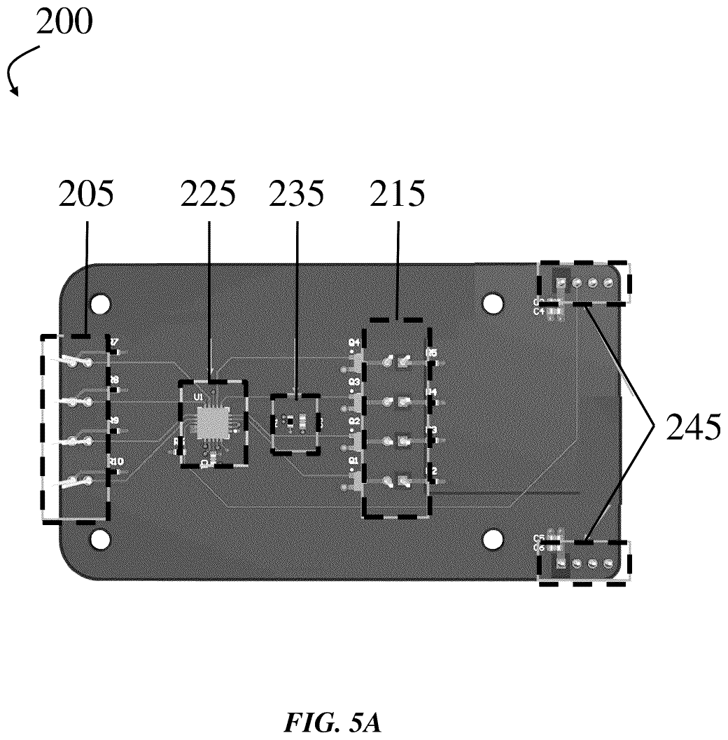

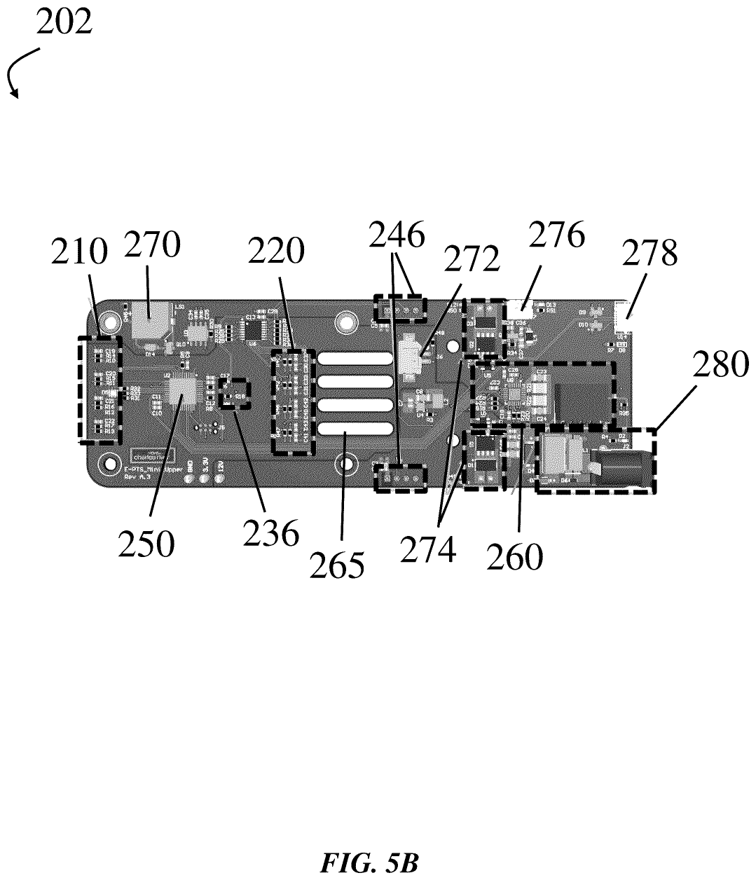

FIGS. 5A and 5B show schematic diagrams detailing the components of the second and first printed circuit boards of an exemplary embodiment of the spectrophotometer, respectively. The exemplary design of the printed circuit boards shown in the figures correspond to the circuit boards of the spectrophotometer shown in FIGS. 1A-1F. Note that the second circuit board in FIG. 5B may correspond to the bottom second circuit board 104 of the fully assembled spectrophotometer of FIG. 1A.

The second printed circuit board 200 in FIG. 5A comprises a second set 205 and a first set of one or more light sources 215. As noted above, the first set of one or more light sources may be aligned with corresponding upstream portions of the sample channels of a sample cartridge during operation and the second set of one or more light sources may be aligned with corresponding downstream sample wells of the sample cartridge during operation. The second set 205 of light sources may correspond to one or more infrared light sources such as one or more infrared light emitting diodes (LEDs) or other appropriate type of light source. The first set of one or more light sources 215 may be configured to emit light in the ultraviolet, visible, or a combination of the forgoing wavelength ranges. The first set of one or more light sources may again be one or more LEDs in some embodiments. A light source driver, such as depicted LED driver 225, may be operatively coupled to and used to control operation of both the second set of one or more light sources 205 and the first set of one or more light sources 215. The second printed circuit board 200 may also include a temperature sensor 235, which is some embodiments may be board mounted, as described previously. The second printed circuit board may also include one or more electrical connectors 245 configured to interconnect the second circuit board 200 and the electrical connectors 246 on the first printed circuit board 202, as shown in FIG. 5B.

The light sources 205 and 215 may be configured to emit light of any suitable wavelength as described elsewhere herein. Additionally, when the second printed circuit board is assembled in a spectrophotometer, the emitted light may be directed through a sample cartridge when present and towards the first printed circuit board. Note that, as configured, spectrophotometric components with relatively short lifetimes are all grouped on the second printed circuit board. As disclosed elsewhere herein, this may be desirable because it may reduce maintenance times and/or minimize cost when there is a need to replace a component on the second circuit board, as the components on the second printed circuit board may be replaced more frequently on average (i.e., they have a shorter average lifespan) then the components located on the first printed circuit board.

The first printed circuit board 202 depicted in FIG. 5B may include one or more infrared light sensors 210 and one or more integrated photodiode modules 220. Herein, there are four infrared light sensors and four integrated photodiode modules on the first printed circuit board, which are arranged such that light from the first set of light sources 205 is directed towards the one or more infrared light sensors and light from the second set of light sources 215 is directed towards the one or more integrated photodiode modules when the two printed circuit boards are assembled and oriented towards one another. The first printed circuit board 200 may further comprise a temperature sensor 236 (e.g., as described above), microcontroller 250, and/or a motor driver and connector 260. Additionally, in some cases, the first printed circuit board 202 may include a signaler 270, cartridge switches 272 and 274, a fan connector 276, a USB connector and/or other communication system 278, a power conditioning connector 280, and/or any other appropriate component.

In accordance with some embodiments, it may be desirable to control operation of the first and/or second sets of light sources 205 and 215 using a pulse width modulation (PWM) controller (e.g., a PWM driver circuit) as the driver 225 which may be used to control an intensity of the first and/or second light sources to emit light with a desired intensity. In some instances, a single PWM driver may be used to control operation of both the first and/or the second set of one or more light sources which may offer benefits related to cost, simplified design, and reliability. However, according to other embodiments, there may be separate individual PWM drivers associated with each light source of the first and/or second set of one or more light sources. Alternatively, in other embodiments, there may be a single PWM driver for the first one or more light sources and a separate single PWM driver for the second set of one or more light sources. Regardless of the number and arrangement of the PWM drivers, or other light source controllers, a control frequency of the PWM may be selected to be significantly greater than a sampling rate of a corresponding sensor (e.g., at least twice as fast or other appropriate frequency) such as an infrared light sensor and/or the integrated photodiode module.

In accordance with some embodiments, the light emitted from the first and/or second set of one or more light sources may be modulated at a rate of greater than or equal to 10 kHz, greater than or equal to 20 kHz, greater than or equal to 50 kHz, greater than or equal to 100 kHz, or greater than or equal to 150 kHz. According to some embodiments, the emitted light may be modulated at higher frequencies, but this may not be cost effective for point of care sensing. In some cases, the emitted light may be modulated at a rate of less than or equal to 200 kHz, less than or equal to 150 kHz, less than or equal to 100 kHz, less than or equal to 50 kHz, or less than or equal to 20 kHz. Combinations of the foregoing ranges are possible (e.g., greater than or equal to 10 kHz and less than or equal to 200 kHz). Other ranges are also possible.

As noted previously, the first set of one or more light sources may be configured to emit UV-Visible light, or other appropriate spectrum of light, associated with detecting a desired sample parameter (e.g., cleavage of a dye, presence of an absorbing and/or scattering particles and/or compounds within the sample, or other appropriate type of parameter capable of being sensed with a spectrophotometer). In some cases, the emitted light from the first set of one or more light sources may have a wavelength of greater than or equal to 300 nanometers, greater than or equal to 390 nm, greater than or equal to 400 nm, greater than or equal to 500 nm, or greater than or equal to 600 nm. In some embodiments, the emitted light from the first set of one or more light sources may have a wavelength of less than or equal to 700 nm, less than or equal to 600 nm, less than or equal to 500 nm, less than or equal to 400 nm, or less than or equal to 390 nm. Combinations of the foregoing ranges are possible (e.g., greater than or equal to the 300 nm and less than or equal to 700 nm, greater than or equal to 400 nm and less than or equal to 700 nm, greater than or equal to 390 nm and less than or equal to 400 nm). Other ranges are also possible.

As also noted previously, the second set of one or more light sources may be configured to sense the presence of a sample within a sample channel. Thus, in some instances, the second set of light sources may be configured to emit infrared (IR) light or other appropriate spectrum of light that may be used to determine the presence of a sample within the sample channels. In some cases, the emitted light from the second set of one or more light sources may have a wavelength of greater than or equal to 900 nm, greater than or equal to 950 nm, greater than or equal to 1000 nm, greater than or equal to 1050 nm. In some embodiments, the emitted light from the second set of one or more light sources may have a wavelength of less than or equal to 1100 nm, less than or equal to 1050 nm, less than or equal to 1000 nm, less than or equal to 950 nm. Combinations of the foregoing ranges are possible (e.g., greater than or equal to the 900 nm and less than or equal to 1000 nm). Other ranges are also possible.

In some embodiments, the integrated photodiode modules and the infrared light sensors may be configured to sense light having a wavelength that corresponds to the light emitted from the first and second set of one or more light sources, respectively. In some cases, the integrated photodiode modules and/or the infrared light sensors may be capable of detecting ranges of wavelengths of light that are broader than the light emitted from the first and/or second set of one or more light sources. In some such cases, this ensures the integrated photodiode modules and/or infrared light sensors sense the light emitted from the light sources. However, embodiments, in which the various photosensitive detectors, such as the integrated photodiode modules and/or the infrared light sensors, only sense a portion of the light emitted from an associated light source are also contemplated.

The sampling rate of the integrated photodiode modules and/or the infrared light sensors may be any of a variety of suitable values, in accordance with some embodiments. The sampling rate of the sensors may be selected based on the application. For example, a relatively low sampling rate may be chosen the monitor the progress of a relatively slow reaction, in some embodiments. Alternatively, in some cases, a relatively fast sampling rate may be chosen to monitor the progress of a relatively fast reaction. According to some embodiments, the sampling rate of the integrated photodiode modules and/or the infrared light sensors may be greater than or equal to 10 Hz, greater than or equal to 50 Hz, greater than or equal to 100 Hz, greater than or equal to 250 Hz, greater than or equal to 500 Hz, or greater than or equal to 750 Hz. In some embodiments, the sampling rate of the sensor may be less than or equal to 1 kHz, less than or equal to 750 Hz, less than or equal to 500 Hz, less than or equal to 250 Hz, less than or equal to 100 Hz, or less than or equal to 50 Hz. Combinations of the foregoing ranges are possible (e.g., greater than or equal to 10 Hz and less than or equal to 100 Hz). Other ranges are also possible.

As mentioned above, the second and first circuit board 200 and 202 may be interconnected connected to each other by electrical connectors 245 and 246. As noted previously, during operation a cavity disposed between the first and second circuit board may be configured to receive a sample cartridge therein, and the IR LEDs 205 may be aligned to transmit light through the one or more sample channels of the sample cartridge towards the infrared light sensors 210. In some cases, a change in transmitted light intensity measured at the infrared light sensors may indicate that there is a sample present in one or more sample channels of the sample cartridge.

Before or after the indication that the sample is present in the sample cartridge, the microcontroller 250 may control the motor driver and to begin driving the motor. The motor may be operatively connected to a pump (e.g., as described previously above), which may be fluidically connected to the sample cartridge. This pump operation may draw fluid from the one or more sample inlets through the one or more sample channels to the one or more sample wells of the sample cartridge. As the solution comprising the sample reaches the one or more sample wells, the first set of light sources (e.g., UV-Visible LEDs) 215 may be aligned to transmit light through the sample wells towards the integrated photodiode modules 220. As disclosed elsewhere herein, changes in the transmitted light may be indicative, for example, of the presence and/or concentration of a species of interest.

Throughout the above-described process, the temperature sensors 235 and 236 on the second printed circuit board 200 and first printed circuit board 202 have been described as being configured to measure the temperature of the heater block, as shown in FIG. 1 of the fully assembled spectrophotometer. In some cases, the temperature sensors 235 and 236 may be used to measure the temperature and provide real time feedback to the microcontroller, or other arrangement of one or more processors, which may operate the one or more heaters associated with the heater block to maintain and/or change the temperature of the solution comprising the sample in the sample cartridge. For example, a control loop may be implemented by the one or more processors based on the temperature signals from the separate temperature sensors to provide a desired operating temperature of the sample cartridge.

Signaler 270 may produce any of a variety of signals, in accordance with some embodiments. Non limiting examples of signals include optical signals (e.g., a flashing LED) or audible signal (e.g., a sound). Signaler 270 may produce a signal when a sample is inserted in the sample inlets of the sample cartridge when present in the spectrophotometer, in some cases. According to some embodiments, signaler 270 may produce a signal when a sample is detected by the spectrophotometer. Additionally, the signaler 270 may produce signals for other reasons, as this disclosure is not so limited.

The remaining components of the first printed circuit board 202 include cartridge switches 272 and 274, a fan connector 276, a USB connector 278, and a power conditioning connector and/or communication system 280. The fan connector may be used to connect a fan, which in some embodiments, may cool the circuitry of the spectrophotometer. In some cases, USB connector and/or other communication system 278 may facilitate off-board control, as described elsewhere herein. Power conditioning connector 280 may be used to provide external power to the spectrophotometer for operation, according to some embodiments.

As alluded to above, the components of the first printed circuit board are generally more expensive and have longer lifetimes compared to the components on the second printed circuit board. Accordingly, grouping the components as illustrated in FIGS. 5A and 5B, may facilitate more cost-effective replacements of the second printed circuit board and/or avoid needless turnover of expensive and/or long lifetime components present on the first printed circuit board.

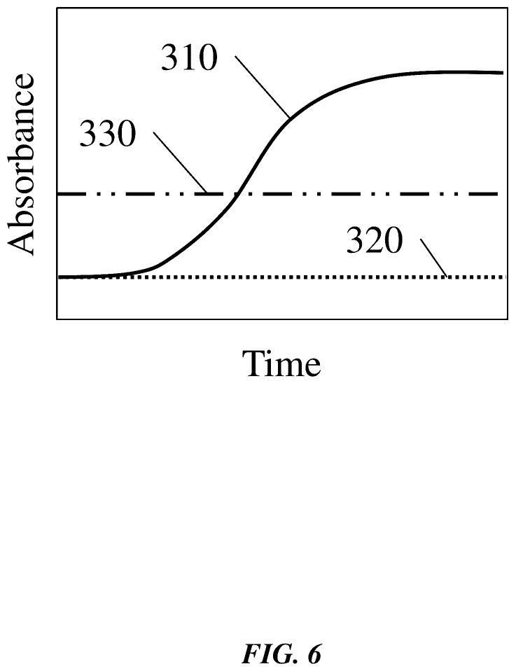

As noted above, a threshold absorbance of a transmitted light signal from a light source to a corresponding sensor may be used to determine either the presence of a sample within a sample channel (e.g., as the sample flows into the channel) and/or the presence of a desired species within a sample disposed in a sample well (e.g., as a reaction progresses over time). FIG. 6 shows a schematic diagram of absorbance versus time data that may be acquired by the spectrophotometer during sensing applications. FIG. 6, shows the absorbance of the solution comprising a sample 310 rises over time, which may occur, for example, as a reaction occurs and a concentration of a compound of interest changes. For instance, a chromogenic endotoxin may be the sample of interest, and in the presence of a catalyst, the chromogenic endotoxin may react and the absorbance of the endotoxin may change over time. As the absorbance rises over a threshold absorbance value 330, the spectrophotometer might be configured to indicate that the sample (e.g., chromogenic endotoxin) is present and/or at a certain concentration based on the time to exceed the detected absorption. Again, it should be understood that the use of an absorption threshold may be used interchangeably with a transmission threshold as the two are related to one another (e.g., the amount of light absorbed by the sample is the amount of light emitted from a light source minus the amount of light transmitted to a corresponding sensor). Such an analysis may be done for any number of separate parallel sample channels and sample wells. Additionally, in some instances, one of the sample channels may be operated as a control channel (e.g., flowing a solution comprising no sample). In the control channel, the absorbance may not change as a function of time, as shown in the absorbance of control channel 320. The presence and measurements performed in the control channel may confirm that the spectrophotometer is operating as designed.

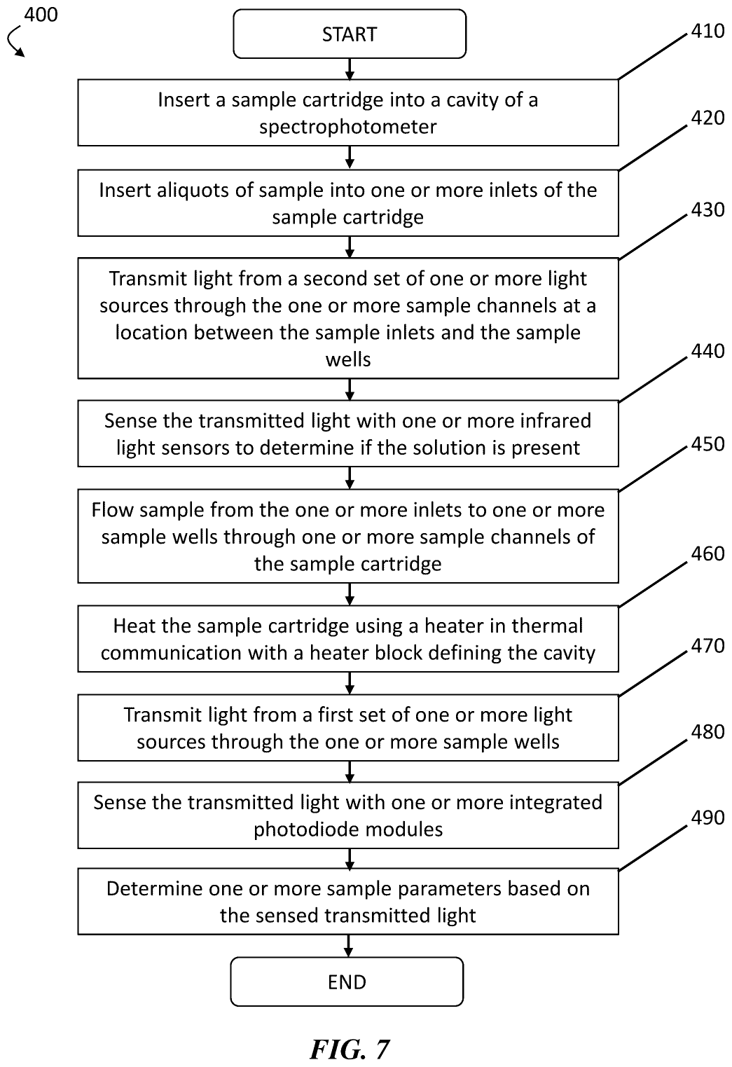

Various methods for using the spectrophotometers described herein are possible. FIG. 7 shows one embodiment of an exemplary method 400 which may be used with any one of the spectrophotometers disclosed herein. To begin with, a sample cartridge may be inserted into the cavity of the spectrophotometer at 410. In some cases, the sample cartridge is inserted such that the first set of one or more light sources, the sample wells, and the integrated photodiode modules are aligned and the second set of one or more light sources, the sample channels, and the infrared light sensors are aligned. Following this, aliquots of solution may be inserted into the one or more inlets of the sample cartridge at 420. Some of the aliquots of solution may comprise a sample of interest, while other aliquots do not comprise the sample of interest (e.g., a control solution). Additionally, it is possible that some or all of the aliquots of solution may comprise a sample of interest. Performing spectrophotometry may further comprise transmitting light from a second set of one or more light sources through the one or more sample channels at a location between the sample inlets and the sample wells at 430. The transmitted light may pass through the sample channels towards the infrared light sensors, which may be configured to sense the transmitted light and determine if the solution is present in the sample channel at 440. For example, a change in the sensed absorbance of light transmitted to the infrared light sensors (e.g., above a threshold absorbance) may indicate the presence of a sample within a corresponding sample channel.

The solution comprising the sample may be flowed from the one or more sample inlets to the one or more sample wells through the one or more sample channels of the sample cartridge at 450. As described elsewhere herein, this may be accomplished by use of a pump or other appropriate source of suction. According to some embodiments, the sample cartridge may be heated by using a heater integrated with or in thermal communication with a heater block at 460 where the sample cartridge is disposed in a cavity formed in the heater block such that a temperature of the sample cartridge may be controlled by the heater an heater block. The temperature of the sample cartridge may be controlled using signals from one or more temperature sensors compressed against one or more surfaces of the heater block, as described elsewhere herein. For example, an average of a temperature sensed by a first temperature sensor compressed against a first surface of the heater block and a second temperature sensed by a second temperature sensor compressed against a second surface of the heater block may be used to control operation of the heater. For example, the measurements from the temperature sensors may be used as feedback to increase or decrease the amount of heat applied by the heater and heater block to the sample cartridge to maintain a desired temperature of the sample cartridge during operation.

Performing spectrophotometry may further comprise transmitting light from the first set of one or more light sources through the one or more sample wells 470. As mentioned above, the first set of one or more light sources may be aligned to transmit light through the one or more sample wells towards the one or more integrated photodiode modules. The integrated photodiode modules may sense the transmitted light from the first set of one or more light sources at 480. The sensed, transmitted light may be used to determine one or more sample parameters at 490. In some cases, it may be desirable to use UV-Visible LEDs as the first set of one or more light sources, to probe the optical properties of the sample in the UV-visible spectrum. As noted previously above, and as elaborated on relative to the examples, this may correspond to determining a time for a detected signal from the integrated photodiode modules to exceed a predetermined threshold absorbance (e.g., a threshold intensity change, a light intensity less than a threshold light intensity, or other appropriate parameter related to absorbance) though other methods of performing spectrophotometry with the disclosed systems may be implemented as well as the disclosure is not so limited.

The above method may be implemented by one or more controllers including at least one processor operatively coupled to the various controllable portions of a spectrophotometer as disclosed herein. The method may be embodied as computer readable instructions stored on non-transitory computer readable memory associated with the at least one processor such that when executed by the at least one processor, the spectrophotometer may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

### Example: Spectrophotometry

The following describes an exemplary test using an spectrophotometer similar to that described above relative to FIGS. 1A-5B. A sample cartridge was inserted into the cavity of the spectrophotometer. The sample cartridge comprised four sample inlets, four sample channels, and four sample wells. An aliquot of solution was placed into each sample inlet, wherein two of the aliquots contained chromogenic endotoxin and two of the aliquots where free of the chromogenic endotoxin. Following this, the pump of the spectrophotometer was used to flow the solution from each of the sample inlets, through the sample channels, to the sample wells. The first set of one or more light sources (e.g., UV—Visible LEDs) was then used to transmit light through the sample wells towards the one or more integrated photodiode modules. The integrated photodiode modules then sensed the transmitted light, measuring the absorbance of each sample channel every two seconds.

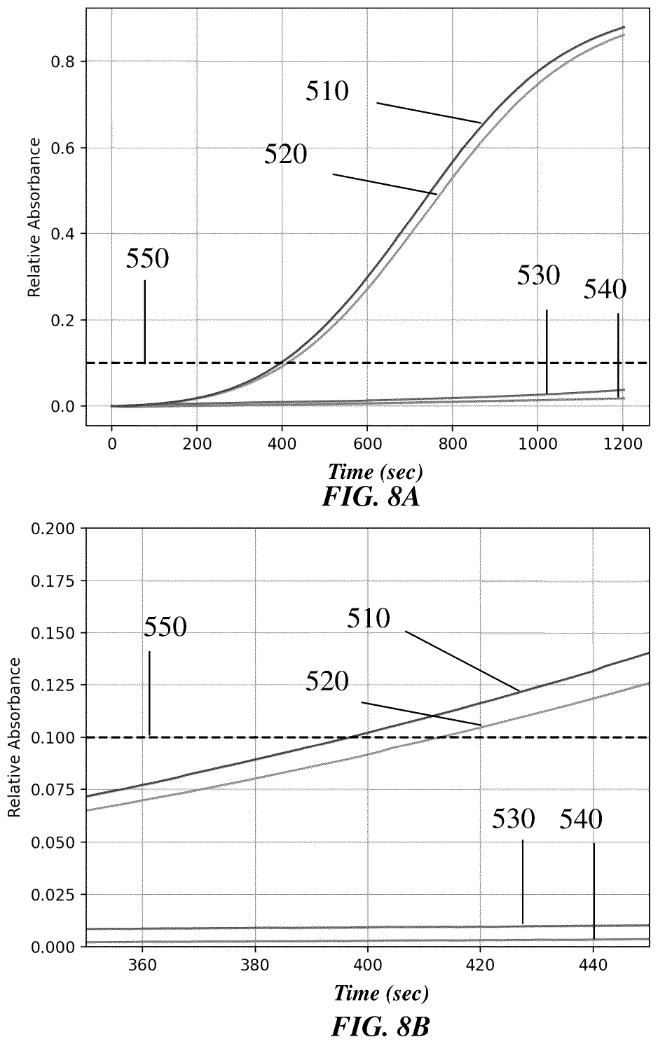

FIGS. 8A-8B show the relative absorbance from the four sample wells. Relative absorbance is the sensed light intensity measured throughout the experiment divided by the initial light intensity (e.g., the absorbance measured in the absence of the solution). The results shown in FIG. 8A show that two sample channels, 510 and 520, contained the chromogenic endotoxin, where the remaining two sample channels 530 and 540 did not contain the chromogenic endotoxin. That is, over time, the relative absorbance measured in sample channels 510 and 520 increased. As the relative absorbance crossed the threshold relative absorbance 550, it indicates that samples 510 and 520 include the chromogenic endotoxin. In contrast, the measured relative absorbance of samples 530 and 540 did not increased significantly over the course of the experiment, indicating that neither sample included the chromogenic endotoxin. FIG. 8B Is an expanded view of FIG. 5A from a time of approximately 350 second to approximately 450 seconds. Here, the relative absorbance measured from sample channels 510 and 520 cross the relative absorbance threshold 550 at different times. The time at which the measured relative absorbance of the channels comprising the species of interest (e.g., the chromogenic endotoxin) crosses the relative absorbing threshold may be used to determine the concentration of the chromogenic endotoxin in the solution within a particular sample well. This may be done, for example, by using a calibration curve of standard solutions containing various amounts of the chromogenic endotoxin. Note that because the exemplary test performed here is generally directed to determining if and/or when the relative absorbance of any of the sample channels crosses the relative absorbance threshold, a relatively low resolution sensor may be sufficient for the test. That is, determining the presence and/or concentration of the chromogenic endotoxin (e.g., or other analytes of interest) may not require diagnostic level resolution as it is simply determining a change in relative light intensities over time to determine a desired parameter, and thus, the integrated photodiode modules disclosed herein provided more than sufficient resolution.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. A spectrophotometer comprising:
a first printed circuit board;
a second printed circuit board;
a cavity disposed between the first printed circuit board and the second printed circuit board, wherein the cavity is configured to receive a sample cartridge disposed therein with one or more sample wells in fluid communication with one or more sample channels formed therein;
one or more integrated photodiode modules disposed on the first printed circuit board; and
a first set of one or more light sources disposed on the second printed circuit board, wherein the first set of one or more light sources are configured to direct light towards the one or more integrated photodiode modules through the one or more sample wells when the sample cartridge is disposed in the cavity.

2. The spectrophotometer of claim 1, wherein the one or more integrated photodiode modules and/or the first set of one or more light sources are board mounted.

3. The spectrophotometer of claim 1, wherein the first set of one or more light sources are configured to emit light having a wavelength of greater than or equal to 300 nm and less than or equal to 700 nm.

4. The spectrophotometer of claim 1, wherein the one or more integrated photodiode modules are configured to sense light having a wavelength of greater than or equal to 300 and less than or equal to 700 nm.

5. The spectrophotometer of claim 1, wherein the one or more integrated photodiode modules are configured to output a signal having a resolution of greater than or equal to 12 bits and less than or equal to 18 bits.

6. The spectrophotometer of claim 1, wherein the one or more integrated photodiode modules are configured to output a signal having a resolution of 16 bits.

7. The spectrophotometer of claim 1, wherein the first set of one or more light sources are configured to emit light having a wavelength of greater than or equal to 390 nm and less than or equal to 400 nm.

8. The spectrophotometer of claim 1, further comprising:
a second set of one or more light sources disposed on the second printed circuit board; and
one or more light sensors disposed on the first printed circuit board and configured to sense light emitted from the second set of one or more light sources.

9. The spectrophotometer of claim 8, further comprising a driver disposed on the second circuit board, and wherein the driver is operatively coupled to the first set of one or more light sources and the second set of one or more light sources.

10. The spectrophotometer of claim 8, wherein a frequency of the first and/or second set of one or more light sources is greater than or equal to 10 kHz and less than or equal to 200 kHz, and wherein a sampling rate of the one or more integrated photodiodes and/or one or more light sensors is greater than or equal to 10 Hz and less than or equal to 1 kHz.

11. The spectrophotometer of claim 8, wherein the one or more light sensors are one or more infrared light sensors.

12. The spectrophotometer of claim 8, wherein the second set of one or more light sources and the one or more light sensors are configured to sense a fluid in the one or more sample channels at a location upstream from the one or more sample wells when the sample cartridge is disposed in the cavity.

13. The spectrophotometer of claim 8, wherein the second set of one or more light sources includes a plurality of light sources.

14. The spectrophotometer of claim 8, wherein the one or more light sensors is a plurality of light sensors.

15. The spectrophotometer of claim 8, wherein the second set of one or more light sources are configured to emit light having a wavelength of greater than or equal to 900 nm and less than or equal to 1000 nm.

16. The spectrophotometer of claim 1, wherein the first set of one or more light sources is a plurality of light sources.

17. The spectrophotometer of claim 1, wherein the one or more integrated photodiode modules is a plurality of integrated photodiode modules.

18. The spectrophotometer of claim 1, further comprising one or more communication devices disposed on the first printed circuit board.

19. The spectrophotometer of claim 1, further comprising a heater, a heater block in thermal communication with the heater, and one or more temperature sensors disposed on the first printed circuit board and/or the second printed circuit board, wherein the cavity is formed in the heater block and the heater block is disposed between the first and second printed circuit boards, and wherein the one or more temperature sensors are compressed against one or more surfaces of the heater block.

20. The spectrophotometer of claim 1, further comprising the sample cartridge disposed in the cavity.

21. A method for performing spectrophotometry on a sample, the method comprising:
inserting a sample cartridge into a cavity disposed between the first printed circuit board and a second printed circuit board;
aligning one or more sample wells of the sample cartridge between one or more integrated photodiode modules disposed on the first printed circuit board and a first set of one or more light sources disposed on the second printed circuit board;
transmitting light from the first set of one or more light sources to the one or more integrated photodiode modules through the one or more sample wells;
sensing the transmitted light with the one or more integrated photodiode modules; and
determining one or more sample parameters based on the sensed transmitted light.

22-49. (canceled)

50. A method for performing spectrophotometry on a sample, the method comprising:
inserting a sample cartridge into a cavity disposed within a heater block between the first printed circuit board and a second printed circuit board;
heating the heater block using a heater that is thermally coupled to the heater block;
sensing a temperature of the heater block with a first temperature sensor disposed on the first printed circuit board and compressed against a first surface of the heater block and a second temperature sensor disposed on the second printed circuit board and compressed against a second surface of the heater block opposite from the first surface.

51-70. (canceled)
